(19) United States
(12) Patent Application Publication
(10) Pub. No.: US 2007/0139378 A1
(43) Pub. Date: Jun. 21, 2007

(54) Wireless computer mouse and presenter having text capability

(76) Inventor: Benjamine J. Siebert, Santa Barbara, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/639,575

(22) Filed: Dec. 15, 2006

Related U.S. Application Data
(60) Provisional application No. 60/751,153, filed on Dec. 16, 2005.

(51) Int. Cl. G09G 5/08

(52) U.S. Cl. 345/163

(57) ABSTRACT

A wireless computer mouse and presenter for use with a computer or media device has the normal functions of a wireless mouse with the addition of an alphanumeric keypad on its case that allows the user to enter numbers and text into the computer directly from the mouse. The case encloses a controller, transmitter and battery. The wireless mouse includes the cursor controller, left and right click buttons and scrolling device of conventional computer mice. The keypad includes a plurality of alphanumeric keys that allows the user to enter numbers and text in a manner similar to text messaging. The preferred embodiment includes quick launch buttons that launch an Internet browser or email program, command buttons that quickly enter commands such as enter and page back, forward and close, and browsing/email phrase buttons that enter common browsing and email phrases. The wireless mouse can also include a laser light pointer.

### CROSS-REFERENCE TO RELATED APPLICATIONS

This patent application claims the benefit of U.S. Provisional Patent Application No. 60/751,153 filed Dec. 16, 2005.

### BACKGROUND OF THE INVENTION

A. Field of the Invention

The field of the present invention relates generally to computer input devices that are utilized to control the movement and operation of a computer cursor. In particular, the present invention relates to computer mice which are configured to wirelessly interact with the computer. Even more particularly, the present invention relates to a wireless computer mouse that is configured with alphanumeric keys to allow the user to wirelessly transmit text information to the computer to control the operation thereof and transmit text thereto.

B. Background

As well known to those skilled in the art, a computer mouse is a computer input device that interacts with the computer to control the movement of the computer's cursor, which is a marker that points to a location on a computer's monitor or display. Initially, the computer mouse was provided with a single button that allowed the user to operate the computer, such as opening a file, at the location of the cursor. The computer mouse has evolved over the years such that the typical presently available mouse has multiple buttons that control various computer operations. The improved computer mouse technology has been achieved through the development of both computer mouse hardware, such as the addition of buttons, wheels and switches, and software that allow the user to select which operations he or she desires the hardware to control.

With regard to movement of the computer cursor, the early computer mice operated by the mechanical movement of a ball located on the underside of the mouse that rolls in response to the movement of the mouse across a surface, such as a mouse pad. Mechanical motion sensors located in the ball enclosure detected movement of the mouse and transmited that movement to the computer cursor. More modern computer mice either utilize optical sensors in the ball enclosure to detect movement of the mouse or utilize a laser, without the need for mechanically moving parts, to detect movement of the mouse in relation to a fixed surface, such as the top of a desk. In addition to issues with regard to long term reliability of the mechanical components of the mechanical or optomechanical mouse operations, the above types of computer mice requires movement of the mouse over a fixed surface, such as a desk or table. A different configuration of a computer mouse utilizes a mechanical device on a surface, typically the upper surface, of the mouse that allows the user to move the computer cursor without moving the mouse across a fixed surface. These type of computer mice have balls, buttons or other devices that the user manipulates to move the computer cursor. The configuration and function of the above-described prior art computer mice are well known to those skilled in the relevant art.

The typical computer mouse connects to the computer utilizing a wire that connects to a serial or USB port on the computer. The wired connected mouse present issues with regard to wires on the user's desk and limitations on the user's movement away from the computer. Many modern computer mice overcome these problems, to a varying extent, by connecting to the computer via wireless operations. The wireless computer mouse requires a receiver device, configured to receive the wireless signal transmitted by the wireless mouse, that connects to the computer, typically at an available USB port thereon. Many computer users also utilize a wireless computer keyboard in conjunction with a wireless mouse, thereby eliminating the wires for these input devices from the user's desktop. Some wireless mice also utilize an upper surface cursor control devices, such as a trackball or button, to effectively free the mouse from having to be used on a desk or other surface located at or near the computer.

While a wireless, upper surface cursor control computer mouse solves the problem of having wires located across the desk and allow the mouse to be utilized away from the computer, they do not totally free the user from the desk or computer, particularly the computer keyboard. As is commonly known, many applications require access to the computer keyboard so the user can type in commands. Even operations that can be substantially accomplished with a cursor and are significantly text free, such as surfing the Internet and the like, still require some amount of text entering capability. For instance, the user typically has a need, which may not be that infrequent, to enter in website addresses and search terms in order to effectively utilize the most common Internet operations. While a wireless computer keyboard can be utilized to type in commands remote from the computer, the user is faced with the somewhat awkward task of trying to balance a wireless keyboard and mouse to accomplish the computer tasks he or she desires, which basically eliminates the freedom to do other activities that could be achieved with wireless computer input operations. As a result, the typical user is not able to effectively utilize the wireless, upper surface cursor control mice to fully separate themselves from the computer and/or the computer keyboard. This problem is particularly noticeable when the user is utilizing the wireless mouse as a presenter to control a computer slide or video display that available for a number of participants to view, such as may be utilized in an academic setting or at a conference. While the wireless mouse will allow certain remote control of the computer video display, the inability to enter text from the mouse requires the user to also utilize the keyboard in order to enter specific text-required commands, like websites, search criteria and email addresses.

Most people in western civilizations have very busy lives, and are often searching for a way to save time or perform multiple tasks simultaneously. Also, especially in the United States, many people wish to exercise as frequently as possible for health and physique reasons. While most people spend hours every day on their computers, whether for personal or work reasons, or a combination of the two, they are generally not able to combine their exercise time with computer usage. One reason for this limitation is that current wireless mice are not configured ergonomically correct for use while a user is exercising. In fact, the size and weight of a typical computer mouse somewhat limits the user's ability to operate the mouse while exercising. In addition, most existing devices must be placed flat on a table or other surface, which is not possible or at least practical while exercising. While the wireless mouse frees the user from a direct physical connection to the computer, currently available wireless mice do not have sufficient multi-function capabilities to be utilized while exercising, and none are known to have a cooperatively configured keypad for entering text into the computer.

Along with the increase in availability and popularity of cellular telephones has come an substantial increase in the popularity of text messaging with such phones. Most cell phones have the same alphanumeric keypad that has been available on standard (i.e., non-wireless) telephones for many years. Unlike the standard telephone, in which the alphabet aspect is not that commonly utilized, many cell phone users are somewhat comfortable and skillful at entering text into the cell phone phonebook and other databases using the alphanumeric keypad. With regard to text messaging, many cell phone users are very familiar with these keys and can quickly enter text messages and send them to others. Predictive software, which predicts what a word will be from the beginning text that is entered, is often utilized with cell phones to speed up the entering of text for text messaging.

What is needed is an improved computer mouse that allows the user to utilize the mouse to move the computer cursor and enter text into the computer remote from the computer, keyboard and desk. The preferred computer mouse will be configured to communicate wirelessly with the computer so as to operate the typical mouse-controlled commands and allow the user to enter text from the mouse so the user will not be required to use a separate keyboard for such text. Preferably, the computer mouse will be configured with a alphanumeric keypad that allows the user to enter numbers and text into the computer in a manner similar to that for text messaging and the like. The preferred computer mouse should have various keys that allow the user to launch computer applications, enter computer commands and enter in standard, frequently used text with the push of a single button. Preferably, the improved computer mouse should be ergonomically comfortable, lightweight and suitable for use in a single hand so that the user may utilize the computer mouse to control and enter text into a computer while performing other tasks, such as exercising.

### SUMMARY OF THE INVENTION

The wireless computer mouse and presenter having text capability of the present invention provides the benefits and solves the problems identified above. That is to say, the present invention discloses a remote computer input device in the form of a computer mouse that allows the user to input commands and text into the computer from a distance, including inputting text data such as letters and numbers, providing volume and playback control for audio/visual media and providing one or more one-button controls for many of the most common computer commands. The preferred embodiment of the present invention includes the typical mouse-type controls and an alphanumeric keypad that allows the user to enter text into the computer in much the same manner that is used for text messaging. The computer mouse of the present invention also includes one or more hot button keys that allows the user to enter commonly utilized text quickly by pushing a single button. With the computer mouse of the present invention, users will be able to more fully utilize their computer while simultaneously exercising or performing other tasks. As such, if people could spend even a portion of the amount of time that they already spend at their computer each day engaged in exercising, they would save time, exercise more often, loose weight and relieve stress, which could significantly reduce the obesity problem that exists in the United States and other countries.

In one general aspect of the present invention, the wireless computer mouse comprises a case that encloses a circuit board on which is mounted a controller, transmitter and one or more batteries to supply electrical power to the other components. As with a standard or conventional computer mouse, the mouse of the present invention includes a cursor controller on the case that is in communication with the controller so as to control the movement of a cursor on the computer monitor, one or more click buttons, such as right and left click buttons to control the operation of the computer and a scroll device for scrolling operations. Unlike conventional computer mice, however, the wireless computer mouse of the present invention includes an alphanumeric keypad having one or more alphanumeric keys that are configured to enter numbers and/or text into the computer. Using the keys on the wireless mouse, the user can enter text into a computer directly from the mouse, without having to use the keyboard or an online screen for entering text. Preferably, the wireless mouse of the present invention also includes one or more quick launch buttons that quickly (i.e., with the push of a single button) launch preset or user-programmable computer application. In the preferred embodiment, the wireless mouse includes a browser button for opening the user's Internet browser and an email button for opening the user's email program. Preferably, the wireless mouse also includes one or more command buttons that are configured to enter commands into the computer by pushing a single button. In a preferred embodiment, the command buttons include an enter button, a tab button and page back, forward and close buttons. The preferred embodiment also includes one or more browsing/email phrase buttons that allow the user to quickly enter in standard phrases, such as “www.”, “@” and “.com”, for Internet browsing or email usage. The above-described wireless computer mouse of the present invention can be part of a computer system that includes a computer and a receiver unit, configured to receive signals from the transmitter, that is attached to the computer. A holder can be provided to secure the wireless computer mouse to a surface, such as a component of an exercise equipment, when it is not being held by the user.

Accordingly, the primary objective of the present invention is to provide an improved wireless computer mouse and presenter having text capability that provides the advantages discussed above and overcomes the disadvantages and limitations associated with presently available computer mice and presenters.

It is also an important object of the present invention to provide a wireless computer mouse that allows the user to operate a computer in a simple and straightforward manner, with an ergonomically comfortable and lightweight computer mouse that has the typical computer mouse functions and the ability to enter text into the computer directly from the computer mouse.

It is also an important object of the present invention to provide a wireless computer mouse that includes a keypad configured to allow the user to enter text into the computer so that he or she may use the computer mouse for activities not available on presently configured computer mice.

It is also an important object of the present invention to provide a wireless computer mouse that has an alphanumeric keypad that allows the user to enter text into the computer in a manner that is the same or similar to text messaging utilized for cellular telephones and the like so that he or she may more effectively utilize the mouse to control the computer.

Another object of the present invention is to provide a wireless computer mouse that has standard mouse controls, an alphanumeric keypad for entering text and one or more hot keys configured to quickly enter commonly utilized text or other information into the computer.

It is also an object of the present invention to provide a wireless computer mouse that can be utilized as a presenter or audio/video controller having standard computer mouse controls and an alphanumeric keypad that allows the user to enter text into a computer so as to better control and more effectively utilize a computer display.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a top perspective view of a preferred embodiment of the wireless computer mouse configured according to the principles and concepts for the present invention;

FIG. 2 is a top view of the wireless mouse of FIG. 1;

FIG. 3 is a right side view of the wireless mouse of FIG. 1;

FIG. 4 is a bottom view of the wireless mouse of FIG. 1;

FIG. 5 is a plan view of the forward end of the wireless mouse of FIG. 1;

FIG. 6 is a perspective view of a wireless mouse system utilizing the wireless computer mouse of the present invention;

FIG. 7 is a top view of a holder for positioning the wireless computer mouse of the present invention on exercise equipment or other devices; and

FIG. 8 is a schematic diagram of the circuit board utilized with a preferred embodiment of the wireless computer mouse of the present invention.

### DETAILED DESCRIPTION OF THE PREFERRED EMBODIMENTS

With reference to the figures where like elements have been given like numerical designations to facilitate the reader's understanding of the present invention, the preferred embodiment of the present invention is set forth below. The enclosed figures and drawings are merely illustrative of a preferred embodiment and represents one of many different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For purposes of this disclosure, references are generally to use of the present invention with a computer, however, those skilled in the art will readily understand that the disclosure herein may apply to other types of devices, machines or equipment having similar operations control capability. In addition, use of the present invention is generally discussed in relation to exercise equipment and use while exercising, however, those skilled in the art will also readily understand that the wireless computer mouse of the present invention can be utilized with other devices, equipment, machines or the like and for use while performing a variety of other types of activities.

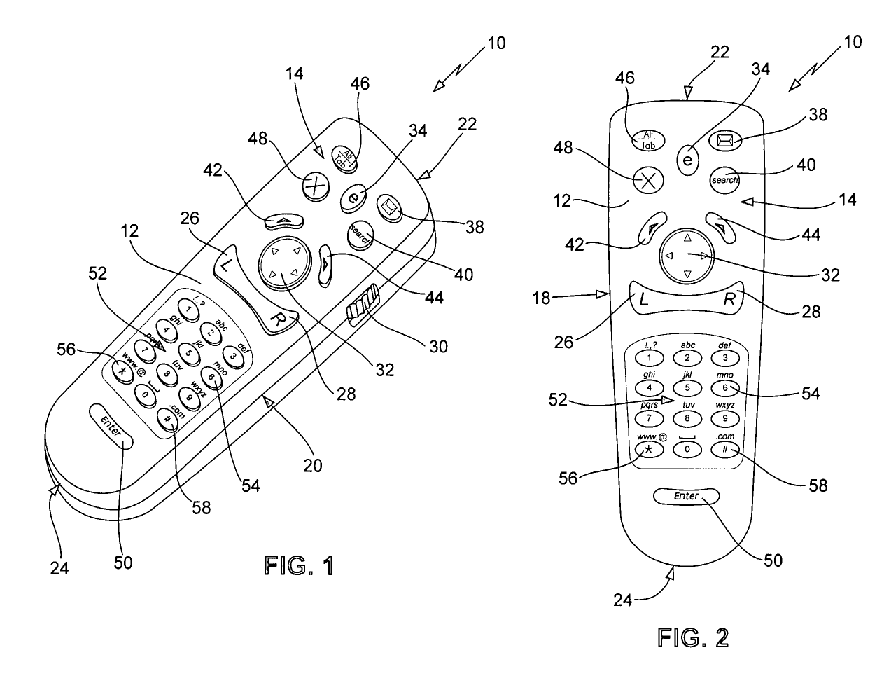

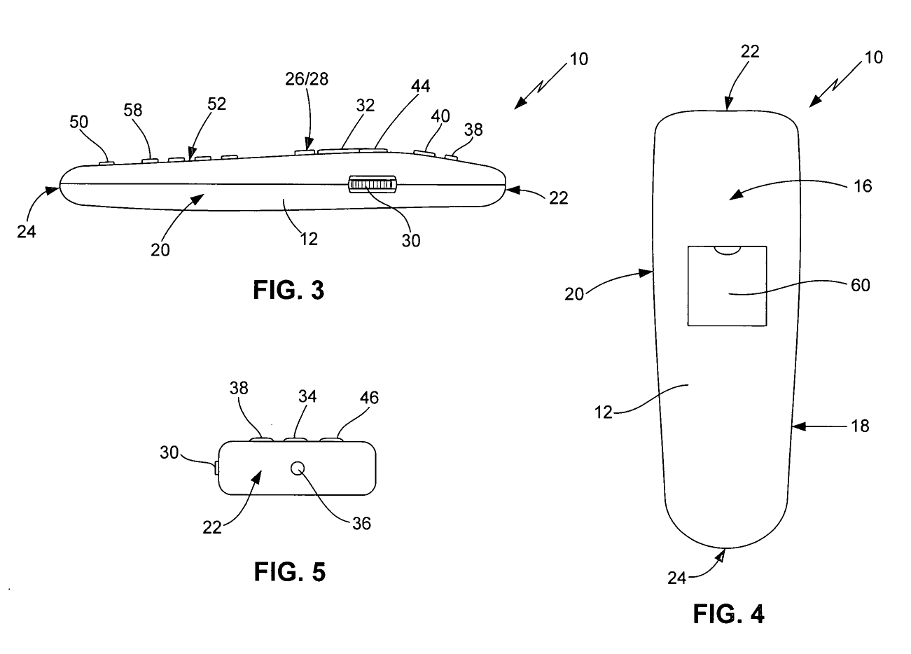

A wireless computer mouse that is manufactured out of the components and configured pursuant to a preferred embodiment of the present invention is shown generally as 10 in the figures. As discussed above, the wireless mouse 10 of the present invention is specifically configured with features allowing it to be used while exercising or while performing other tasks that are preferably done remote from a computer, keyboard and desk. The wireless mouse 10 of the present invention is also specifically configured to be useful as a presenter or for as a multi-media controller. As shown in FIGS. 1 through 5, case 12 of wireless mouse 10 has an upper surface 14, lower surface 16, left side 18, right side 20, forward end 22 and rearward end 24. Case 12 is configured with a generally open interior chamber that encloses the electronics, including the circuit board described below and shown in the schematic of FIG. 8, and other components. In a preferred embodiment of the present invention, case 12 is sized and configured to fit in the palm of a user's hand, be removably mounted or secured to a stationary component of a piece of exercise equipment or be mounted to various other devices or surfaces. In one configuration, computer mouse 10 has a case 12 that is approximately the same size and general configuration as a typical cellular telephone. For instance, case 12 can be approximately 5 inches long, 1.75 inches wide at the top end 22, 1.5 inches wide at the bottom end 24 and 0.5 to 0.7 inches deep. The above dimensions are provided merely as an example, as those skilled in the art will readily recognize that a wide variety of different sizes and configurations are possible for case 12 of wireless mouse 10 of the present invention.

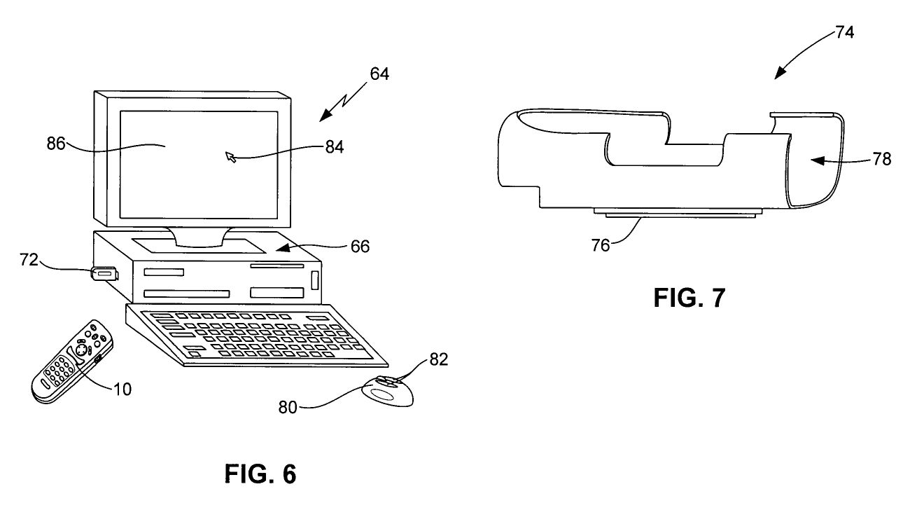

Functionally, the preferred computer mouse 10 has at least the same buttons and features that are generally available on a conventional computer mouse, shown as 80 in FIG. 6, whether wired or wireless. As best shown on FIGS. 1 and 2, the user buttons include a left-click button 26 that is typically positioned under the index finger and a right-click button 28 that is typically positioned under the middle finger (similar to a conventional mouse), as shown in FIG. 2. These click buttons 26 and 28 have the same functions as the standard click buttons 82 on the conventional mouse 80 shown in FIG. 6. A button, switch, dial or other scroll device, such as thumbwheel 30, is positioned on the right side 20 of case 12 and is configured to activate a scrolling type activity on the computer display to allow the user to scroll a page or perform other similar scrolling operations. Pressing the scroll device 30 inward initiates a volume control feature that allows the user to control the volume of an audio device. A touchpad, trackball, rocker switch or other similarly configured multi-function button, device or cursor controller 32 allows the user to control the cursor 84 on the computer monitor 86 (i.e., similar to a track ball type device found on some conventional computer mice) of a typical computer 66, as shown in FIG. 6. If desired, the positioning of these buttons and devices can be reversed or otherwise modified to better suit a left or right handed user.

In the preferred embodiment, wireless mouse 10 includes a number of “hot” or quick launch buttons, command buttons and phrase buttons that allow the user to easily and instantly perform one or more computer tasks or enter frequently utilized text. As set forth below, some of these quick launch, command or phrase buttons are configured for two separate functions, one that is initiated by pressing and then releasing the button and one that is initiated by pressing and holding for a set period of time, such as two seconds. The quick launch buttons are configured to quickly launch a computer application on computer 66. One of the quick launch buttons is an “e” or browser button 34 that provides a one-button launch for the user's Internet browser, such as Microsoft's Internet Explorer® or the like, that is initiated by pressing browser button 34. In a preferred configuration, this button is also configured for the user to turn on a laser light pointer 36 at the forward end 22 of case 12, as best shown in FIGS. 5 and 8, by holding browser button 34 down for approximately two seconds. Releasing browser button 34 turns the laser light pointer 36 off. Another quick launch button is the “envelope” or email button 38 to open the user's email program, such as Yahoo®, Outlook® or the like, by pressing email button 38. In the preferred embodiment, holding email button 38 down for two seconds opens the user's Internet favorites menu so that he or she may quickly go to their favorite websites. Another quick launch button is the “Search” search engine button 40 that opens the user's favorite Internet search engine (such as Google® or the like), which is activated by holding the search engine button down for approximately two seconds. In a preferred embodiment, search engine button 40 also functions as a backspace button when it is pressed (without holding down).

The preferred embodiment of wireless mouse 10 also includes a number of command buttons that are provided to allow the user additional functionality, particularly with regard to Internet browsing and email applications. One such button is the page back button 42 and page forward button 44 that allows the user to page back or page forward, respectively, between Internet websites in the same manner as the left or right arrows in the user's web browser or perform similar back and forward operations on the computer. In the preferred embodiment, wireless mouse 10 also includes an “Alt. Tab” or tab button 46 to allow the user to tab forward on the computer, by pressing tab button 46 or to easily switch between open windows applications by holding the tab button 46 down for approximately two seconds. Another quick command button is the “X” or close button 48 that minimizes an open window when pressed or automatically closes the most recently opened screen, which will be particularly useful with unwanted pop-up displays, when pressed and held for two seconds. The close button 48 generally functions in the same manner as the “X” button on the upper right hand portion of an open window on a computer screen. Another command button is the “Enter” button 50, which is programmed to operate in the same manner as the enter key on the standard computer keyboard.

As shown in FIGS. 1 and 2, wireless mouse 10 is also provided with an alphanumeric keypad 52 having a plurality of alphanumeric keys, shown generally as 54, which allow the user to enter numbers and text into a computer program application, particularly when utilizing the email program or while browsing the Internet. In the preferred embodiment, keypad 52 is of the phone-type that is commonly utilized to create text-messages and store data into a telephone. As known to those familiar with text messaging, the use of the alphanumeric keys 54 on keypad 52 allows the user to enter text into the computer, a feature heretofore not available with computer mice, whether wired or wireless. Although keypad 52 shown in the figures is configured with the number/letter sharing alphanumeric keys 54 commonly found on telephones, including cellular telephones, the invention is not so limited. For instance, wireless mouse 10 can be provided with a keypad 52 that includes separate keys 54 for groups of numbers and letters or for individual numbers and letters. In general, the common twelve key arrangement is typically preferred by those skilled in the art as a balance between the number of keys, size of keys and size of the case 10 necessary to display and allow access to the individual keys.

In the preferred embodiment, two of the alphanumeric keys 54 are configured as browsing/email phrase buttons that allow the user to quickly enter in commonly utilized Internet browsing and email phrases so as to eliminate the user having to enter these frequently entered text. One of these buttons is the or star button 56, which in a preferred embodiment is programmed to automatically enter the text “www.” or “@” or similar Internet browsing/email phrases. Another browsing/email phrase button is the “#” or pound button 58, which is programmed to enter the text “.com” or the like. As known by those skilled in the art, these browsing/email phrase buttons can be programmed differently than described herein and, in fact, can be configured to be user-programmable for other types of browsing/email phrases. In addition, other browsing/email phrase buttons can also be provided on wireless mouse 10 of the present invention.

As set forth above, the quick launch buttons, command buttons and phrase buttons are configured to allow the user to easily and instantly perform one or more computer tasks or enter frequently utilized text. One or more of these buttons can be preset by the manufacture or be user-programmable, thereby allowing the user to select what applications he or she desires to quickly launch or which commands and/or phrases he or she desires to be accessible by a single-click operation. In addition, one or more of these buttons can be configured to launch audio/visual applications, for use as a game controller and/or to perform other similar functions (collectively, used as an “audio/visual controller”). As an audio/ visual controller, the wireless mouse 10 of the present invention can be utilized with a PC-to-TV wireless converter, which transmits the computer monitor display to a receiver plugged into a television to effectively turn the television into a computer, to remotely control the computer and, therefore, the display on the television. In addition, wireless mouse 10 can also be utilized with a pair of virtual reality glasses that provides a heads-up display that would allow a user to roam around the house while using wireless mouse 10 to control computer 66 or as an audio/visual controller. Depending on cellular technology, it may also be useful away from the home through the Internet.

The case 12 of wireless mouse 10 can be provided with a pistol grip type of configuration, cushion foam, plastic, or any other material that feels comfortable to someone exercising or who may otherwise be utilizing wireless mouse 10 of the present invention. As shown in FIG. 4, the lower surface 16 can have a battery compartment door 60 which allow access to a battery 62, shown on the schematic of FIG. 8. As known to those skilled in the art, wireless mouse 10 can be configured to be rechargeable, having electrical contacts (not shown) that are placed against corresponding contacts located in a recharge base, a plug-in electrical recharging device or the like (i.e., similar to those utilized with cellular telephones). In a preferred embodiment, battery 62 is a typical, watch type battery that provides sufficient power for the components of wireless mouse 10 without requiring much space inside case 12.

In a preferred embodiment of the present invention, wireless mouse 10 described above is configured to be a component of a computer system 64, such as that shown in FIG. 6, having a computer 66 that is in communication with and operatively controlled by wireless mouse 10. As shown in FIG. 8, the alphanumeric keys 54 of keypad 52 operatively engage a computer processing controller 68 that provides the operating logic for wireless mouse 10, which is transmitted to computer 66 by a transmitter 70. As well known to those skilled in the art, laser light pointer 36, battery 52, controller 68 and transmitter 70 are preferably mounted on a circuit board that is enclosed within case 12. The system 64 of the present invention, shown in FIG. 6, also includes a receiver unit 72 that connects to computer 66 and is configured to receive the wireless signal from transmitter 70 of wireless mouse 10. In a preferred embodiment, receiver unit 72 is of the type that plugs into a USB port on computer 66 and receives its power through the USB port (as opposed to having its own power supply). As with existing or prior art wireless mice, transmitter 70 and receiver unit 72 are configured to transmit and receive electrical RF signals without interfering with the operation of computer 66. Preferably, transmitter 70 of wireless mouse 10 is configured to transmit the signal a sufficient distance so the user will not be required to be very close to computer 66 in order for wireless mouse 10 to enter commands in or otherwise control computer 66. In a preferred embodiment, the transmitter 70 is configured to transmit its signal approximately 100 feet.

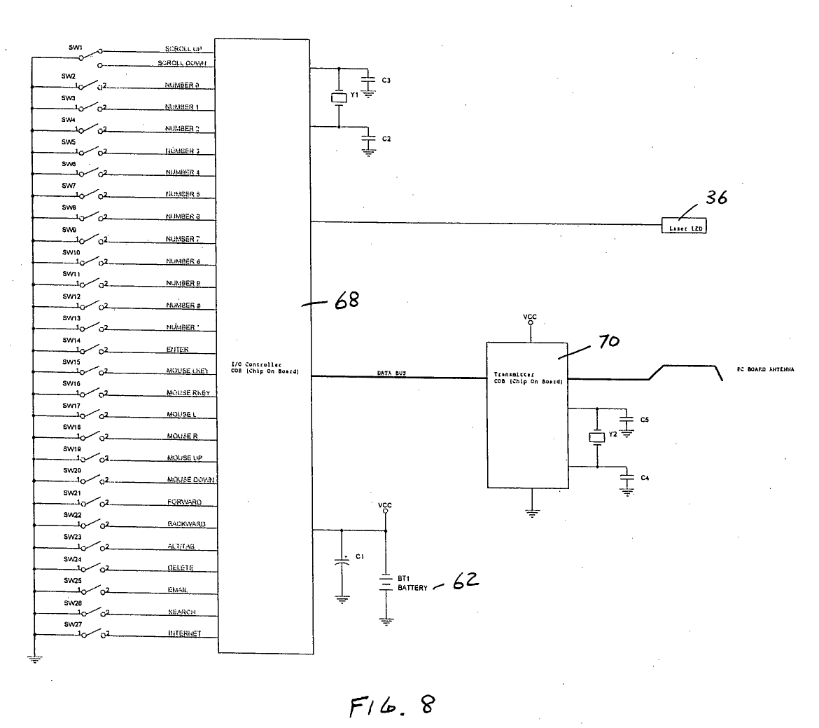

In one embodiment, the wireless computer mouse 10 of the present invention is configured to mounted, preferably indirectly, to an exercise machine or other surface by means of a cooperatively configured holder 74, shown in FIG. 7. In the embodiment shown, holder 74 is adapted to be mounted, by use of an adhesive pad 76 or like attachment mechanism, to the surface where it is convenient to the user to have wireless mouse 10 when he or she desires to utilize it to control computer 66. In the embodiment shown, case 12 is cooperatively sized and configured with holder 74 such that wireless mouse 10 can slide in and out of mouse cavity 78 for hand-held or mounted use, yet be securely held by holder 74 when wireless mouse 10 is intended to be disposed therein so it will not fall out of holder 74 during use. Various other attachment mechanisms, such as velcro, straps, snaps or the like can be utilized with holder 74. Alternatively, an attachment mechanism can be placed directly on the lower surface 16 of case 12, or elsewhere on case 12. In addition, case 12 can be provided with a strap, clip or other mechanism to allow the user to wear around his or her neck or otherwise attach to the user.

A number of features and/or components can be added to wireless mouse 10 of the present invention to improve the functionality to the user thereof. For instance, controller 68 can be provided with the predictive software utilized in many cellular telephones that reduces the amount of keys necessary for entering text by predicting the word based on the initial letters entered by the user. Many people find the use of predictive software an advantage when typing in text, which will also apply to entering text in computer 66. Another enhancement to wireless mouse 10 is the addition of an MP3 or like music player into case 12 that allows the user to record his or her favorite music and play it back through wireless mouse 10. Preferably, case 12 would be provided with a headphone jack receiver that is configured to receive the user's headphone jack. In this manner, the user could read or watch information on the monitor 86 of computer 66 that was selected by entering text with keypad 52 and performing other mouse functions with wireless mouse 10 while he or she listens to music through the player. Yet another component that can be added to wireless mouse 10 is voice recording capability, which would allow the user to record his or her voice in order to capture thoughts that come to him or her while exercising or performing other activities and using wireless mouse 10 of the present invention. A variety of other features and/or components could also be incorporated into wireless mouse 10 to improve its function as a computer controller and/or an audio/visual controller.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A wireless computer mouse for controlling and entering text and commands on a computer, comprising:
a case enclosing a controller and a transmitter, said transmitter in communication with said controller and in wireless communication with said computer;
a cursor controller on said case in communication with said controller, said cursor controller configured to control the movement of a cursor on a monitor of said computer;
one or more click buttons on said case in communication with said controller, each of said click buttons configured as standard mouse buttons to control the operation of said computer; and
a keypad on said case in communication with said controller, said keypad having one or more keys configured to enter numbers and/or text on said computer.

2. The wireless computer mouse according to claim 1 further comprising a scroll device on said case in communication with said controller, said scroll device configured for scrolling or volume control operations on said computer.

3. The wireless computer mouse according to claim 1 further comprising one or more quick launch buttons on said case in communication with said controller, each of said quick launch buttons configured to quickly launch a computer application on said computer.

4. The wireless computer mouse according to claim 3, wherein said one or more quick launch buttons comprises a browser button configured to open an Internet browser.

5. The wireless computer mouse according to claim 3, wherein said one or more quick launch buttons comprises an email button configured to open an email program.

6. The wireless computer mouse according to claim 3, wherein one or more of said quick launch buttons are user-programmable.

7. The wireless computer mouse according to claim 1 further comprising a laser light pointer in said case and in communication with said controller.

8. The wireless computer mouse according to claim 1 further comprising one or more command buttons configured to enter commands on said computer.

9. The wireless computer mouse according to claim 8, wherein said command buttons comprise one or more page control buttons.

10. The wireless computer mouse according to claim 8, wherein said command buttons further comprise a tab button and an enter button.

11. The wireless computer mouse according to claim 1 further comprising one or more browsing/email phrase buttons.

12. The wireless computer mouse according to claim 11, wherein said browsing/email phrase buttons are incorporated into said keypad.

13. The wireless computer mouse according to claim 1, wherein said wireless computer mouse is configured as an audio/visual controller.

14. A wireless computer mouse for controlling and entering text and commands on a computer, comprising:
a case enclosing a controller, a transmitter and one or more batteries, said transmitter in communication with said controller and in wireless communication with said computer, said one or more batteries configured to supply electrical power to said controller and said transmitter;
a cursor controller on said case in communication with said controller, said cursor controller configured to control the movement of a cursor on a monitor of said computer;
one or more click buttons on said case in communication with said controller, each of said click buttons configured as standard mouse buttons to control the operation of said computer;
a scroll device on said case in communication with said controller, said scroll device configured for scrolling or volume control operations on said computer;
a keypad on said case in communication with said controller, said keypad having one or more keys configured to enter numbers and/or text on said computer; and
one or more quick launch buttons on said case in communication with said controller, each of said quick launch buttons configured to quickly launch a computer application on said computer.

15. The wireless computer mouse according to claim 14 further comprising one or more command buttons configured to enter commands on said computer.

16. The wireless computer mouse according to claim 14 further comprising one or more browsing/email phrase buttons.

17. The wireless computer mouse according to claim 14, wherein said one or more quick launch buttons comprises a browser button configured to open an Internet browser and an email button configured to open an email program.

18. The wireless computer mouse according to claim 14 further comprising a laser light pointer in said case and in communication with said controller.

19. A computer system, comprising:
a computer having a monitor;
a receiver unit attached to said computer; and
a wireless mouse having a case enclosing a controller and a transmitter, a cursor controller on said case in communication with said controller, one or more click buttons on said case in communication with said controller and a keypad on said case in communication with said controller, said transmitter in communication with said controller and in wireless communication with said receiver unit, said cursor controller configured to control the movement of a cursor on said monitor, each of said click buttons configured as standard mouse buttons to control the operation of said computer, said keypad having one or more alphanumeric keys configured to enter numbers and/or text on said computer.

20. The computer system according to claim 19, wherein said wireless mouse further comprises one or more quick launch buttons on said case in communication with said controller, each of said quick launch buttons configured to quickly launch a computer application on said computer.

21. The computer system according to claim 19, wherein said wireless mouse further comprises one or more command buttons configured to enter commands on said computer and one or more browsing/email phrase buttons.

22. The computer system according to claim 19 further comprising a holder configured to securely hold said wireless controller.
